(19) United States
(12) Patent Application Publication
(10) Pub. No.: US 2022/0092493 A1
(43) Pub. Date: Mar. 24, 2022

(54) Systems and Methods for Machine Learning Identification of Precursor Situations to Serious or Fatal Workplace Accidents

(71) Applicant: Keith Douglas Bowers, Phoenix, AZ (US)

(72) Inventor: Keith Douglas Bowers, Phoenix, AZ (US)

(21) Appl. No.: 17/484,773

(22) Filed: Sep. 24, 2021

Related U.S. Application Data
(60) Provisional application No. 63/082,949, filed on Sep. 24, 2020.

(51) Int. Cl. G06Q 10/06; G06N 20/20; G06F 16/28

(52) U.S. Cl. CPC G06Q 10/0635; G06F 16/285; G06N 20/20

(57) ABSTRACT

An industrial safety advisor system includes a preprocessing module configured to receiving a plurality of workspace safety reports and produce a processed sentence set; an embedding module configured to receive the processed sentence set and a produce a set of high-dimensional embeddings; a severity classifier module, including a first trained machine learning module, configured to filter and match the set of high-dimensional embeddings to one or more preexisting safety reports provided within a datastore to thereby produce a set of clustered sentences; a semantic similarity module, including a second trained machine learning module, configured to derive semantic similarity metrics based on the set of clustered sentences; and a summary preparation module configured to provide a safety risk assessment based on the semantic similarity metrics.

### CROSS-REFERENCE TO RELATED APPLICATIONS

This application claims priority to U.S. Prov. Pat. App. No. 63/082,949, filed Sep. 24, 2020, the entire contents of which are hereby incorporated by reference.

### TECHNICAL FIELD

The present invention relates, generally, to systems and methods for reducing workplace safety risks and, more particularly, to using machine learning techniques for identifying potentially dangerous workplace situations that might lead to serious or fatal workplace accidents.

### BACKGROUND

Currently known methods for predicting and preventing serious workplace-related injuries are unsatisfactory in a number of respects. For example, despite recent advances in technology, there are no comprehensive techniques for learning from the many thousands of past serious or fatal workplace accidents, or for identifying potential serious accident situations from such information. Given the vast number of documented workplace safety reports available to the public (e.g., from governmental sources), it would be intractable for a human to reliably review the reports by hand and/or using standard keyword search strategies. Furthermore, no human reviewer could possibly be familiar with the full range of potential workplace fatalities. Accordingly, it would be beneficial for organizations to identify potentially serious workplace problems ahead of time, so they could focus their efforts on reducing workplace risk and improving worker safety.

Systems and methods are therefore needed that overcome these and other limitations of the prior art.

### SUMMARY OF THE INVENTION

Various embodiments of the present invention relate to systems and methods for identifying potentially dangerous workplace situations to thereby reduce workplace safety risks using a novel machine learning system trained using a corpus of past workplace injury reports. In accordance with the present subject matter, an industrial safety advisor system receives, from a user or client, workplace safety information contained in accident and related reports and flags the reports that are similar to past accidents that have resulted in fatalities or serious accidents. The flagged reports indicate workplace situations that warrant a safety risk assessment and possibly increased safety precautions. These reports can be of a wide range of free-text workplace reports, but are commonly short text summaries of workplace accidents or comments or concerns about workplace processes or situations.

In general, as further described below, the process begins with accident and related text reports from the user's workplace being prepared for processing by parsing the individual reports and removing “distractor” words and other such words that have been found by the present inventor to degrade results. The reports are then converted into individual sentences, rather than contiguous reports that comprise multiple sentences. The processing that follows is then conducted at the sentence level, rather than the report level.

More particularly, sentences are converted to high dimensional embeddings using a pretrained artificial neural network (ANN). These high dimensional matrices are a mathematical representation of the sentence meaning, and will generally be located closely in high dimensional space to other sentences with similar meaning. User sentences are then provided to a classifier designed to remove sentences that rarely or never represent fatal or serious accidents. These non-serious sentences are removed to improve matching in the next step. The classifier was trained on a large data set of both serious and non-serious accident types using high dimensional clustering algorithms to increase generalization and improve semantic matching.

The sentences resulting from the classifier step preceding this step are matched against a large set of actual workplace fatality reports and the closest matches are returned along with summary and related information. Users can further train the classifier and fine tune results by indicating which types of reports to emphasize and to input text strings of their own devising. User may risk rank fatality categories based upon frequency of a fatality category in both the user's reports and the fatality category frequency in the corpus of past workplace injury reports.

### BRIEF DESCRIPTION OF THE DRAWING FIGURES

The present invention will hereinafter be described in conjunction with the appended drawing figures, wherein like numerals denote like elements, and:

FIG. 1 is a conceptual block diagram illustrating an industrial safety advisor system in accordance with various embodiments;

FIG. 2 is a conceptual flowchart illustrating application of the present invention to an example client's workplace to accomplish SIF risk reduction;

FIG. 3 is an industry-specific example of risk ranked fatality modes useful in describing the present invention;

FIG. 4 is a conceptual flowchart illustrating the processing of potentially serious injuries or fatalities (pSIF) from government (or other agency) fatality reports; and

FIG. 5 is an example report presented in “review mode” for use in improving training.

### DETAILED DESCRIPTION OF PREFERRED EXEMPLARY EMBODIMENTS

The present subject matter relates to machine learning systems and methods for identifying precursor situations relating to serious or fatal workplace accidents. As a preliminary matter, it will be understood that the following detailed description is merely exemplary in nature and is not intended to limit the inventions or the application and uses of the inventions described herein. Furthermore, there is no intention to be bound by any theory presented in the preceding background or the following detailed description. In the interest of brevity, conventional techniques and components related to data analytics, natural language processing, workplace safety issues, database systems, and the like need not be described herein.

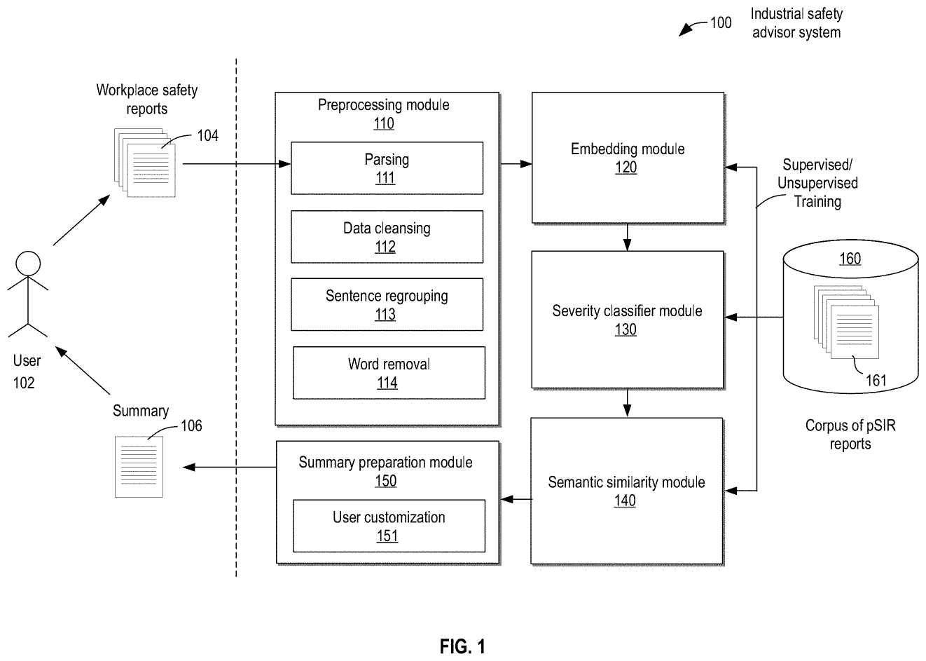

FIG. 1 is a conceptual block diagram of an industrial safety advisor system (or simply “system”) 100 in accordance with various embodiments of the present invention. In general, system 100 includes a preprocessing module 110, a summary preparation module 150, an embedding module 120, a severity classifier module 130, a semantic similarity module 140, and a database 160 including a corpus of potentially serious incident or fatality (pSIF) reports and other information (generally, “workplace accident information”) 161 relating to prior workplace safety issues. Information 161 is used for supervised and/or unsupervised training of various modules within system 100, such as embedding module 120, severity classifier module 130, and semantic similarity module 140. Workplace accident information 161 includes, for example, U.S. Occupational Safety and Health Administration (OSHA) data, primarily from their public, anonymized Fatal and Catastrophic Incident reports. Additional reports may be added as they become available to improve training.

From the standpoint of user 102, the process begins by submitting one or more safety reports 104 to pre-processing module 110. Safety reports 104 make take many forms, but typically include free-form text of accident summaries and related safety documents gathered by industrial safety organizations. The reports document workplace accidents, accident near misses, employee provided safety concerns, and related observations in an unstructured text description.

In response, system 100 returns a summary 106 including one or more similar serious incident or fatality reports for each client report (from workplace accident information 161) that resemble a previous recorded fatality or serious accident. Summary 106 may include various data, information, and metadata such as general categories of matches, numbers of matches, and degree of similarity. User 102 may then consult summary 106 to evaluate their current safety system for improvement areas that may have been underappreciated before using system 100.

In some embodiments, user 102 can set a level of similarity or set other preferences through a user customization module 151 and suitable user interface (not illustrated). For example, user 102 may indicate that they would prefer more or fewer of particular report categories, or user 102 may create entirely new accident types to include or exclude in subsequent summaries 106.

From the standpoint of system 100, the process begins when reports 104 are received by preprocessing module 110. As illustrated, preprocessing module 110 includes a parsing module 111, a data cleansing module 112, a sentence regrouping module 113, and a word removal module 114.

Parsing module 111 parses the received text into individual words indexed and labeled for part of speech using any suitable parsing algorithm. Data cleansing module 112 then cleans the text by removing unhelpful words and parts of speech, such as pronouns and articles. Sentence regrouping module 113 then regroups the text into separate sentences. In accordance with one aspect of the present invention, a substantial number of comparisons and operations that follow are performed at the sentence level, rather than the entire user supplied text or entire document level. Subsequently, word removal module 114 is used to remove words that are particularly indicative of a minor accident. For example, the word “laceration” is removed so as not to interfere with matching with fatality reports. That is, a minor accident reports might use the words “laceration” or “cut”, while a fatality or serious injury report might contain the words “amputation” or “mangled”. Removing these types of words that tend to indicate a lower severity of accident has been found to improve results.

Next, embedding module 120 is used to convert each sentence (i.e., previously processed sentence) into high dimensional embeddings. In one embodiment, for example, the system uses a 300 dimensional embedding model trained on Wikipedia (or similar corpus of text) then trained with a broad range of workplace safety reports and related documents (information 161 in database 160). This embedding places words with similar meaning close to each other (i.e., using some convenient distance metric) in high-dimensional space. For example, the word “foot” would be located very close to the words “ankle” and “toe” in the word embedding space. This is a way to mathematically approximate word meanings and similarities.

Severity classifier module 130 then uses a previously trained machine learning classifier to filter out unrelated sentences and match user sentences to similar serious accident fatality reports from database 160. Module 130 assigns each user sentence a label, of which there are two types: negative and positive. Negatively labeled sentences are filtered out, and positively labelled sentences are kept for semantic similarity module 140. In general, negative labels are trained on a large collection of industry reports that are not likely to be similar to past serious or fatal accidents, and positive labels are trained on workplace accident information 161. In one embodiment, approximately 800 negative and positive sentence grouping or clusters are used for classification.

A variety of clustering and classification algorithms may be employed to produce the results described above. In one embodiment, the initial clustering of training documents is performed in accordance with the algorithm set forth in Berge L, Bouveyron C, Girard S “HDclassif: An R Package for Model-Based Clustering and Discriminant Analysis of High-Dimensional Data.” Journal of Statistical Software, 46(6), 1-29 (2012) http://www.jstatsoft.org/v46/i06/.)

Semantic similarity module 140 derives semantic similarity between actual fatality report sentences and user report sentences produced by previous modules (110, 120, and 130). The highest similarity reports are returned to the user along with helpful related information (summary 106). The highest similarity reports can then be used to highlight potential safety risks. For example, a user-provided accident report might describe a minor finger injury resulting from a rolling press would match with actual fatalities resulting from accidental entanglement with rolling presses that have been documented in actual workplace fatality reports. This would serve to both highlight the potential risk and to provide useful details that make designing new safety precautions easier.

Summary 106 is preferably configured to provide easy-to-interpret, actionable results. For example, it might include matched fatality report or reports, replacing sentences that matched the fatality reports with the original entire reports that contained the matched sentence. User can further train algorithm to include or exclude certain types of results.

Having thus given an overview of an industry safety advisor system in accordance with various embodiment, various features of the system will now be described in further detail.

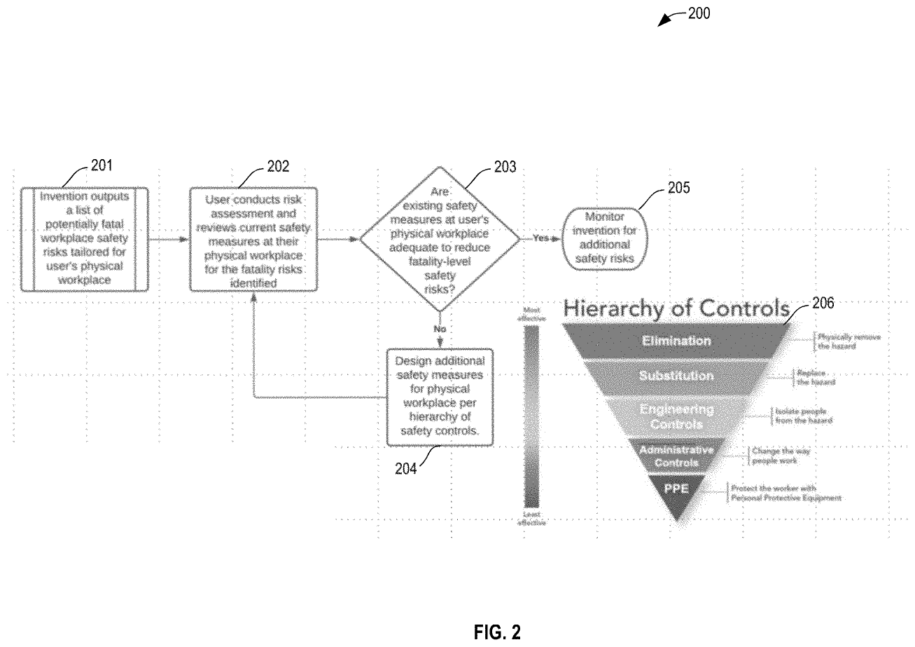

Referring to FIG. 2, a conceptual flowchart 200 illustrates application of the present invention to an example client's workplace to accomplish serious injuries or fatalities (SIF) risk reduction. More particularly, process 200 relates to what is done after a summary or result is generated via the system of FIG. 1. That is, as indicated at step 201, a system in accordance with the present invention outputs a list of potentially fatal workplace safety risks tailored for the user's physical workplace. Next, at 202, the user conducts a risk assessment and reviews current safety measures within the workplace or environment for the SIF risks identified.

Next, at 203, a determination is made as to whether existing safety measures at the user's workplace are adequate to reduce fatality-level safety risks. If so, then processing continues to step 205, and the environment continues to be monitored for additional safety risks; otherwise, processing continues to step 204, wherein additional safety measures are designed for the workplace based on, for example, a hierarchy of safety controls.

For example, item 206 illustrates, from top to bottom, a non-limiting hierarchical list of controls that may be applied to the workplace. At the top is “elimination,” in which the hazard is physically removed from the workplace. Next is “substitution,” in which the hazard is replaced with something less hazardous. This is followed by “engineering controls,” which isolating people from the hazard, “administrative controls,” in which an attempt is made to change the way people work, and “PPE”, which involves protecting the worker with personal protective equipment or the like.

It will be appreciated that the post-report safety report illustrated in FIG. 2 is not intended to be limiting, and that a variety of such actions (and control hierarchies) may be used. The key aspect of this process is, in some cases, the act of modifying the physical workplace itself in response to the report. That is, the method illustrating in FIGS. 1-2 is not merely abstract: it takes tangible input (in the form of reports) and, through artificial intelligence, produces a report that leads to post-processing activity in the form of modifications to the physical environment and/or the workers employed therein.

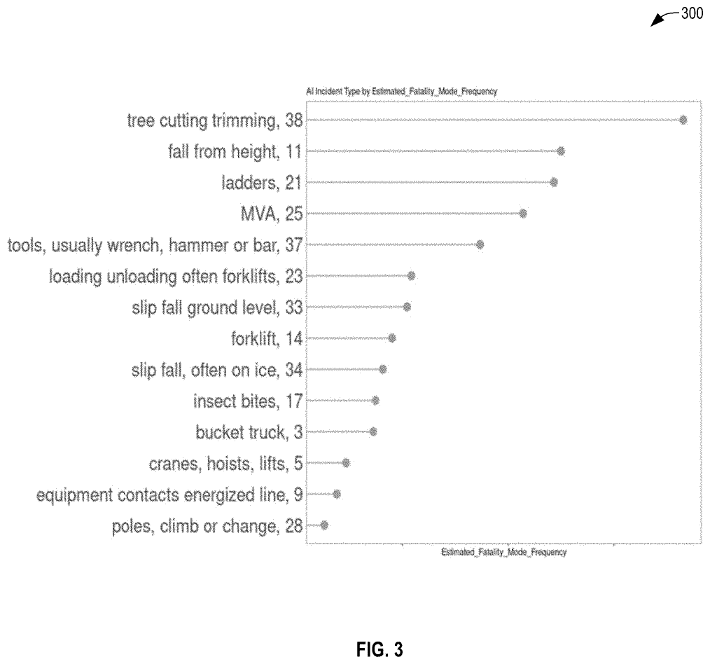

For the purposes of illustration, FIG. 3 is an industry-specific example of risk ranked fatality modes 300 useful in describing the present invention, and might represent actions listed in the summary 106 of FIG. 1. That is, the horizontal axis illustrates the estimated fatality mode frequency, and the horizontal bars are associated with various activities, such as tree cutting/trimming, fall from a height, ladder climbing, etc. This relative ranking of fatality modes in FIG. 3 are a function of three key parameters: (1) how frequently the activity occurs, (2) how risky a given scenario is (how often it leads to serious injury or fatalities), and (3) how frequently the fatalities occur in the governmental records or other data corpus.

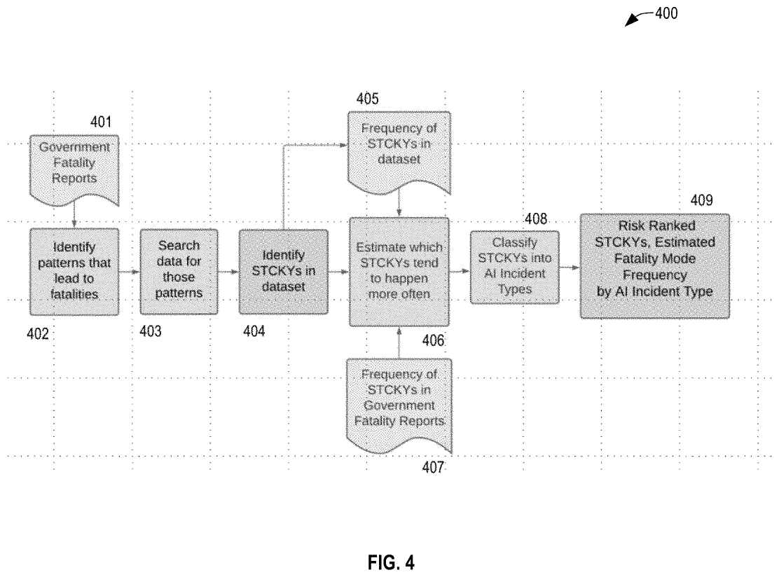

FIG. 4 is a conceptual flowchart 400 illustrating the processing of potentially serious injuries or fatalities (pSIF) from government (or other agency) fatality reports. In this figure, the acronym “STCKY” is a colloquialism for “stuff that can kill you,” and is used synonymously with “pSIF”, described above. As shown, method 400 includes taking as its input a variety of government reports 401. Next, the system identifies any patterns that lead to fatalities (402), and searches the data for those patterns (403). Next, the system identifies STCKYs in the dataset (404). The frequencies of these occurrences are determined for the dataset (405), and estimate of which STCKYs tend to happen more often is determined (406) (using, for example, the frequency of STCKYs in applicable government fatality reports 407). This estimate is used to classify STCKYs into incident types (408), which are then risk ranked (409) as illustrated in FIG. 3, described in detail above.

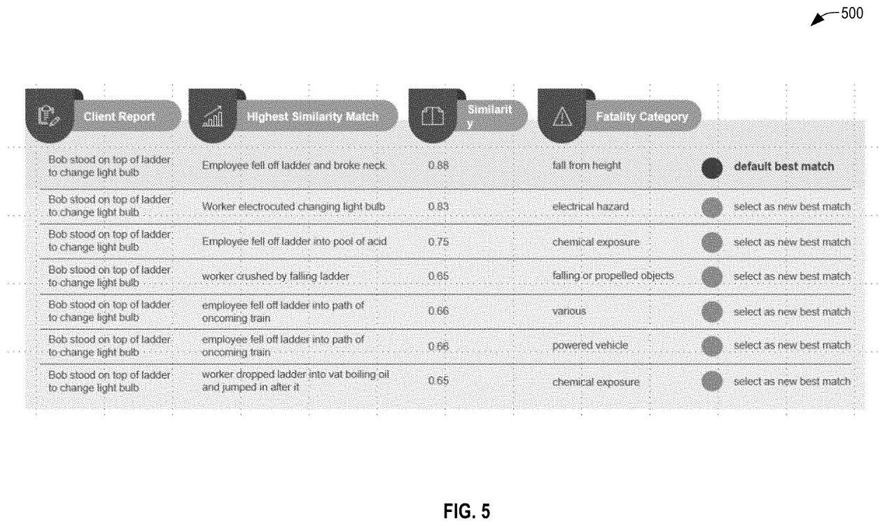

While reports generated by the system may vary in content and form, FIG. 5 is an example report 500 presented in “review mode” for use in improving training. That is, the report takes the form of a table with five columns: (1) a client report column specifying an action (in this case, standing on top of a ladder to change a light bulb), (2) the highest similarity match for each entry, (3) a similarity metric (in this example, a real number ranging from 0.0 to 1.0), (4) the fatality category (e.g., fall from height, electrical hazard, etc.), and (5) a column that allows the user to manually select a new best match, thereby allowing the system to learn from the best match assigned by the user (i.e., a form of long-term, incremental supervised learning).

In general, what have been described are systems and methods for reviewing workplace accident reports and related documents to identify those that are similar to actual workplace fatalities or serious accidents. The goal of this system is to help safety leaders in an organization reduce workplace safety risk by flagging situations described in minor incidents that could result in serious or fatal incidents in the future. For example, a user-supplied free-text accident report describing a minor collision between a forklift and a warehouse worker might return examples of past workplace fatalities arising from forklift collisions with humans. These results help safety professionals identify many potentially serious situations that would not be identified manually. Manual approaches are very subjective and severely limited by lack of familiarity with the universe of past workplace fatalities, as well as the enormous cost and time needed to review thousands of workplace accident reports by hand.

The system has been described above in terms of functional and/or logical block components and various processing steps (e.g., system 100 of FIGS. 1-5). It should be appreciated that such block components may be realized and implemented by any number of hardware, software, and/or firmware components configured to perform the specified functions. For example, an embodiment of the present disclosure may employ various stand-alone computing devices, software-as-a-service (SaaS), platform-as-a-service (PaaS), or infrastructure-as-a-service (IaaS) systems, integrated circuit components, digital signal processing elements, field-programmable gate arrays (FPGAs), Application Specific Integrated Circuits (ASICs), logic elements, look-up tables, network interfaces, or the like, which may carry out a variety of functions under the control of one or more microprocessors or other control devices either locally or in a distributed manner.

The various functional modules described herein (such as embedding module 120, severity classifier module 130, and semantic similarity module 140) may be implemented entirely or in part using a machine learning or predictive analytics model. In this regard, the phrase “machine learning” model is used without loss of generality to refer to any result of an analysis that is designed to make some form of prediction, such as predicting the state of a response variable, clustering words, determining association rules, and performing anomaly detection. Thus, for example, the term “machine learning” refers to models that undergo supervised, unsupervised, semi-supervised, and/or reinforcement learning.

Such models may perform classification (e.g., binary or multiclass classification), regression, clustering, dimensionality reduction, and/or such tasks. Examples of such models include, without limitation, artificial neural networks (ANN) (such as a deep learning networks, recurrent neural networks (RNN), and convolutional neural networks (CNN)), decision tree models (such as classification and regression trees (CART)), ensemble learning models (such as boosting, bootstrapped aggregation, gradient boosting machines, and random forests), Bayesian network models (e.g., naive Bayes), principal component analysis (PCA), support vector machines (SVM), clustering models (such as K-nearest-neighbor, K-means, expectation maximization, hierarchical clustering, etc.), linear discriminant analysis models, and time-series analysis (such as simple moving average (SMA) models, autoregressive integration moving average (ARIMA) models, and generalized autoregressive conditional heteroscedasticity (GARCH) models.

Any data generated by the above systems may be stored and handled in a secure fashion (i.e., with respect to confidentiality, integrity, and availability). For example, a variety of symmetrical and/or asymmetrical encryption schemes and standards may be employed to securely handle data at rest and in motion. Without limiting the foregoing, such encryption standards and key-exchange protocols might include Triple Data Encryption Standard (3DES), Advanced Encryption Standard (AES) (such as AES-128, 192, or 256), Rivest-Shamir-Adelman (RSA), Twofish, RC4, RC5, RC6, Transport Layer Security (TLS), Diffie-Hellman key exchange, and Secure Sockets Layer (SSL). In addition, various hashing functions may be used to address integrity concerns associated with the data.

In summary, what has been disclosed is a preprocessing module configured to receive a plurality of workspace safety reports and produce a processed sentence set; an embedding module configured to receive the processed sentence set and a produce a set of high-dimensional embeddings; a severity classifier module, including a first trained machine learning module, configured to filter and match the set of high-dimensional embeddings to one or more preexisting safety reports provided within a datastore to thereby produce a set of clustered sentences; a semantic similarity module, including a second trained machine learning module, configured to derive semantic similarity metrics based on the set of clustered sentences; and a summary preparation module configured to provide a safety risk assessment based on the semantic similarity metrics. In some embodiments, the safety risk assessment includes at least: categories of matches, numbers of matches, and degree of similarity to one or more of the preexisting safety reports. In some embodiments, the preprocessing module comprises a parsing submodule, a data cleansing submodule, a sentence regrouping submodule, and a word-removal submodule.

A method for improving safety within a work environment in accordance with one embodiment includes: receiving a plurality of workspace safety reports associated with the workspace environment; producing a processed sentence set based on the workspace safety reports; determining, with an embedding module, a set of high-dimensional embeddings; filtering and matching the set of high-dimensional embeddings to one or more preexisting safety reports provided within a datastore to thereby produce a set of clustered sentences; deriving semantic similarity metrics based on the set of clustered sentences; producing a summary safety risk assessment based on the semantic similarity metrics; and modifying the work environment in accordance with the summary safety risk assessment.

In addition, those skilled in the art will appreciate that embodiments of the present disclosure may be practiced in conjunction with any number of systems, and that the systems described herein are merely exemplary embodiments of the present disclosure. Further, the connecting lines shown in the various figures contained herein are intended to represent example functional relationships and/or physical couplings between the various elements. It should be noted that many alternative or additional functional relationships or physical connections may be present in an embodiment of the present disclosure.

As used herein, the terms “module” or “controller” refer to any hardware, software, firmware, electronic control component, processing logic, and/or processor device, microprocessor, open source computing platform, general purpose computer, individually or in any combination (either distributed or consolidated in one component), including without limitation: application specific integrated circuits (ASICs), field-programmable gate-arrays (FPGAs), dedicated neural network devices (e.g., Google Tensor Processing Units), electronic circuits, processors (shared, dedicated, or group) configured to execute one or more software or firmware programs, a combinational logic circuit, and/or other suitable components that provide the described functionality.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

1. An industrial safety advisor system comprising:
a preprocessing module configured to receive a plurality of workspace safety reports and produce a processed sentence set;
an embedding module configured to receive the processed sentence set and a produce a set of high-dimensional embeddings;
a severity classifier module, including a first trained machine learning module, configured to filter and match the set of high-dimensional embeddings to one or more preexisting safety reports provided within a datastore to thereby produce a set of clustered sentences;
a semantic similarity module, including a second trained machine learning module, configured to derive semantic similarity metrics based on the set of clustered sentences; and
a summary preparation module configured to provide a safety risk assessment based on the semantic similarity metrics.

2. The system of claim 1, wherein the safety risk assessment includes at least: categories of matches, numbers of matches, and degree of similarity to one or more of the preexisting safety reports.

3. The system of claim 1, wherein the preprocessing module comprises a parsing submodule, a data cleansing submodule, a sentence regrouping submodule, and a word-removal submodule.

4. The system of claim 1, wherein the safety risk assessment presents a best match associated with a given client report event, and the user is provided a user interface to modify the best match, the result of which is used for further training of the second semantic similarity module.

5. A method for improving safety within a work environment:
receiving a plurality of workspace safety reports associated with the workspace environment;
producing a processed sentence set based on the workspace safety reports;
determining, with an embedding module, a set of high-dimensional embeddings;
filtering and matching the set of high-dimensional embeddings to one or more preexisting safety reports provided within a datastore to thereby produce a set of clustered sentences;
deriving semantic similarity metrics based on the set of clustered sentences;
producing a summary safety risk assessment based on the semantic similarity metrics; and
modifying the work environment in accordance with the summary safety risk assessment.

6. The method of claim 5, wherein the safety risk assessment includes at least: categories of matches, numbers of matches, and degree of similarity to one or more of the preexisting safety reports.

7. The method of claim 5, wherein the preprocessing module comprises a parsing submodule, a data cleansing submodule, a sentence regrouping submodule, and a word-removal submodule.

8. The method of claim 5, wherein the safety risk assessment presents a best match associated with a given client report event, and the user is provided a user interface to modify the best match, the result of which is used for further training of the second semantic similarity module.

9. Non-transitory medium bearing machine-readable instructions configured to instruct a processor to perform the steps of:
receiving a plurality of workspace safety reports associated with the workspace environment;
producing a processed sentence set based on the workspace safety reports;
determining, with an embedding module, a set of high-dimensional embeddings;
filtering and matching the set of high-dimensional embeddings to one or more preexisting safety reports provided within a datastore to thereby produce a set of clustered sentences;
deriving semantic similarity metrics based on the set of clustered sentences;
producing a summary safety risk assessment based on the semantic similarity metrics; and
modifying the work environment in accordance with the summary safety risk assessment.

10. The non-transitory medium of claim 9, wherein the safety risk assessment includes at least: categories of matches, numbers of matches, and degree of similarity to one or more of the preexisting safety reports.

11. The non-transitory medium of claim 9, wherein the preprocessing module comprises a parsing submodule, a data cleansing submodule, a sentence regrouping submodule, and a word-removal submodule.

12. The non-transitory medium of claim 9, wherein the safety risk assessment presents a best match associated with a given client report event, and the user is provided a user interface to modify the best match, the result of which is used for further training of the second semantic similarity module.
